(19) United States
(12) Patent Application Publication
(10) Pub. No.: US 2003/0147588 A1
(43) Pub. Date: Aug. 7, 2003

(54) Step-chirped, sampled optical waveguide gratings for WDM channel operations and method of manufacture therefor

(75) Inventors: Jing-Jong Pan, Milpitas, CA (US); Feng-Qing Zhou, San Jose, CA (US)

Correspondence Address: RITTER, LANG & KAPLAN, 12930 SARATOGA AE. SUITE D1, SARATOGA, CA, 95070, US

(73) Assignee: Lightwaves 2020, Inc., Milpitas, CA

(21) Appl. No.: 10/067,684

(22) Filed: Feb. 4, 2002

(51) Int. Cl. G02B 6/34

(52) U.S. Cl. 385/37

(57) ABSTRACT

The present invention provides for an optical waveguide device comprising a plurality of step-chirped, sampled fiber Bragg gratings which are chirped in a step-wise manner from one sampling segment to the next according to a chirp rate. Each sampling segment has a uniform grating period within the sampling segment. The step-chirped grating chirp rate may be selected to compensate for dispersion of signals over a transmission fiber connected to the optical waveguide device. The use of the step-chirped, sampled grating relaxes the tight chirp requirement of the chirped, sampled grating. The sampled grating may be step-chirped by writing an initial sampling segment on the fiber, and then stretching the fiber before writing each subsequent sampling segment. After writing the sampling segments, the fiber is returned to its original length, so that subsequently written sampling segments after each stretch have increasingly smaller grating periods.

### BACKGROUND OF THE INVENTION

The present invention is related to optical waveguide grating devices, which might be especially useful in WDM networks, and, more particularly, to fiber Bragg gratings with step-chirped, sampled gratings.

Fiber Bragg gratings, and other optical waveguide gratings, are useful components in many fiberoptic and telecommunications systems. In fiberoptic networks, such gratings, including sampled gratings, have been proposed for many applications, such as filtering, multiplexing/demultiplexing, and gain equalization in broadband WDM (Wavelength Division Multiplexing) systems where the particular wavelength of an optical signal defines a communication channel over a network system and is used to direct the signal through the network to its intended destination. Other applications include dispersion compensation, especially for long-distance transmissions. For example, see “Novel designs for sampled grating-based multiplexer-demultiplexers,” W. H. Loh, F. Q. Zhou and J. J. Pan, Optics Letters, Vol. 24, No. 21, Nov. 1, 1999, pp. 1457-1459, and U.S. Pat. No. 6,317,539, entitled “INTERLEAVED SAMPLED AND CHIRPED OPTICAL WAVEGUIDE GRATINGS FOR WDM CHANNEL OPERATIONS AND RESULTING DEVICES,” issued Nov. 13, 2001 to W. H. Loh, F. Q. Zhou and J. J. Pan. In passing, it should be noted that for the purposes of this application, the terms, “WDM” and “WDM networks,” are used broadly to include DWDM (dense WDM) and other advanced WDM networks unless stated otherwise.

While sampled fiber Bragg gratings are very attractive for many applications, linearly chirped, sampled phase masks are difficult to fabricate and expensive due to time-consuming requirements of manufacture. Precision is critical and difficult to achieve. Hence linearly chirped, sampled gratings are expensive and rare.

The present invention, on the other hand, provides for chirped (either linearly or nonlinearly), sampled fiber Bragg gratings, which are different from previous chirped, sampled fiber Bragg gratings, and much easier to manufacture. Costs are lowered so that many of the applications described above are more easily realizable and at lower cost.

### SUMMARY OF THE INVENTION

The present invention provides for an optical waveguide device comprising a plurality of step-chirped, sampled fiber Bragg gratings which are chirped in a step-wise manner from one or more sampling segments to the next. Each sampling segment has a uniform grating period within the sampling segment. The step-chirped grating periods may vary from one sampling segment to another sampling segment according to a chirp rate, which may be linear. The parameters of the step-chirped grating chirp rate may be selected to compensate for the dispersion of signals over a transmission fiber connected to the optical waveguide device.

The present invention also provides for manufacturing a step-chirped, sampled fiber grating by writing an initial sampling segment on an optical fiber, and then stretching the fiber before writing each subsequent sampling segment. After writing all the sampling segments, the fiber is returned to its original length, so that subsequently written sampling segments after each stretch have increasingly smaller grating periods. A single uniform phase mask can be used. Alternative, the section of the fiber can be permanently stretched after writing a sampling section with the single phase mask to obtain a step-chirp in the sampling segments along the fiber.

### BRIEF DESCRIPTION OF THE DRAWINGS

FIG. 1 is a schematic representation of a conventional sampled fiber Bragg grating;

FIG. 2 is a representation of a conventional linearly chirped, sampled fiber Bragg grating;

FIG. 3 is a representation of a step-chirped, sampled fiber Bragg grating according to one embodiment of the present invention;

FIGS. 4A is a graph of reflectivity versus wavelength for the step-chirped, sampled fiber Bragg grating of FIG. 3 against an equivalent linearly chirped, sampled fiber Bragg grating; FIG. 4B is a graph of transmissivity versus wavelength for same two compared fiber Bragg gratings;

FIG. 5A is a graph of reflectivity and transmissivity for selected wavelengths for a step-chirped, sampled fiber Bragg grating; FIG. 5B is a graph of group delay for selected wavelengths for the same step-chirped, sampled fiber Bragg grating;

FIG. 6 is a plot of group delay for selected wavelengths for step-chirped, sampled fiber Bragg grating with different step lengths;

FIG. 7 is a representation of a step-chirped, sampled fiber Bragg grating in which two sampling segments forming a chirp step, according to another embodiment of the present invention;

FIG. 8 is a representation of a step-chirped, sampled fiber Bragg grating in which the sampling segments are also chirped, according to another embodiment of the present invention; and

FIG. 9 is a schematic illustration of an apparatus for forming a step-chirped, sampled fiber Bragg grating on an optical waveguide grating device according to an embodiment of the present invention.

### DESCRIPTION OF THE SPECIFIC EMBODIMENTS

In optical waveguide grating devices, the medium of the waveguide through which light signals are transmitted is periodically or nearly periodically modulated to reflect the light signals at particular wavelengths. Though optical waveguides appear in different forms, such as waveguide-bearing substrates, the fiber Bragg grating has been the recent focus of much development. Hence while the present invention is described in terms of fiber Bragg gratings, it should be understood that much, if not all, of the aspects of the present invention are adaptable to other types of optical waveguide grating devices as well.

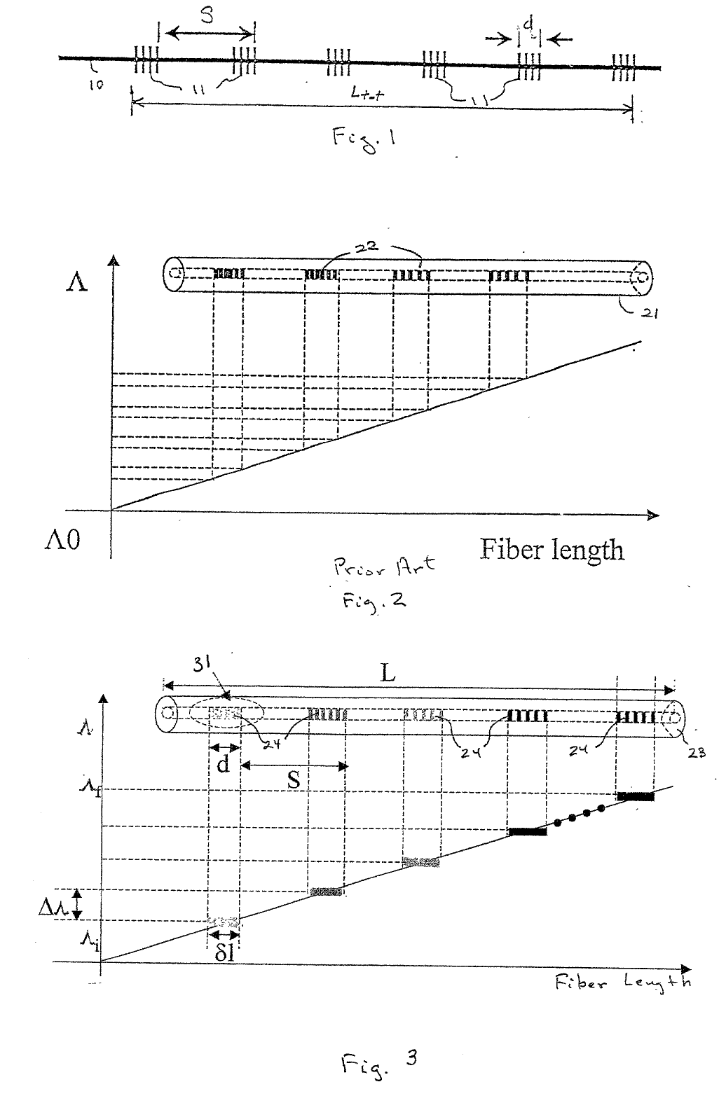

A Bragg grating is formed in an optical waveguide device in which the refractive index of the light-conducting waveguide is periodically or nearly periodically modulated. In a fiber Bragg grating, the core of the optical fiber is modulated. Typically, the modulation of the refractive index is symbolically shown as short bars perpendicular to the line representing the optical fiber. A sampled fiber Bragg grating is a grating whose refractive index modulation amplitude (and/or phase) is itself modulated periodically along the structure, as illustrated by FIG. 1. The grating is effectively partitioned into segments 11 of length d separated by the sample period S along an optical fiber 10.

Sampled gratings have been described with linear or nonlinear chirp in the grating period, and sometimes in combination with chirp or uniformity in the sampling period, for use in different applications. However, as part of interleaver devices, for example, a sampled grating with a uniform grating period has difficulty in achieving the desired bandwidths for the WDM channels. A sampled chirped grating, such as a sampled chirped fiber Bragg grating, does make it easier to attain the desired bandwidths. However, since the bandwidth also depends strongly upon the index modulation Δn, the chirp is difficult to define. The bandwidth of a fiber Bragg grating depends upon two parameters, namely the modulation amplitude of the index of refraction and the chirp rate of the grating. For a sampled fiber Bragg grating, the same is true but now the sampling duty cycle also affects the bandwidth. For filter applications in WDM systems, the bandwidth and cross-talk (or isolation between WDM channels) requirements are somewhat contradictory. A wide bandwidth increases cross-talk and a narrow bandwidth lowers cross-talk. Due to the limitation of the modulation amplitude of the photosensitive refraction index, a sampled uniform fiber Bragg grating usually does not have sufficient bandwidth for an application. Chirp is required to increase the bandwidth. However, the bandwidth also depends upon the index modulation and the sampling duty cycle, and it is difficult to determine a phase mask's chirp rate before an approximate determination of the index modulation when the fiber Bragg grating is created with the phase mask. (Details of phase mask technology which is used to manufacture fiber Bragg gratings are explained below.) Therefore, the advantage of adding chirp to the sampled grating does not appear so advantageous after all.

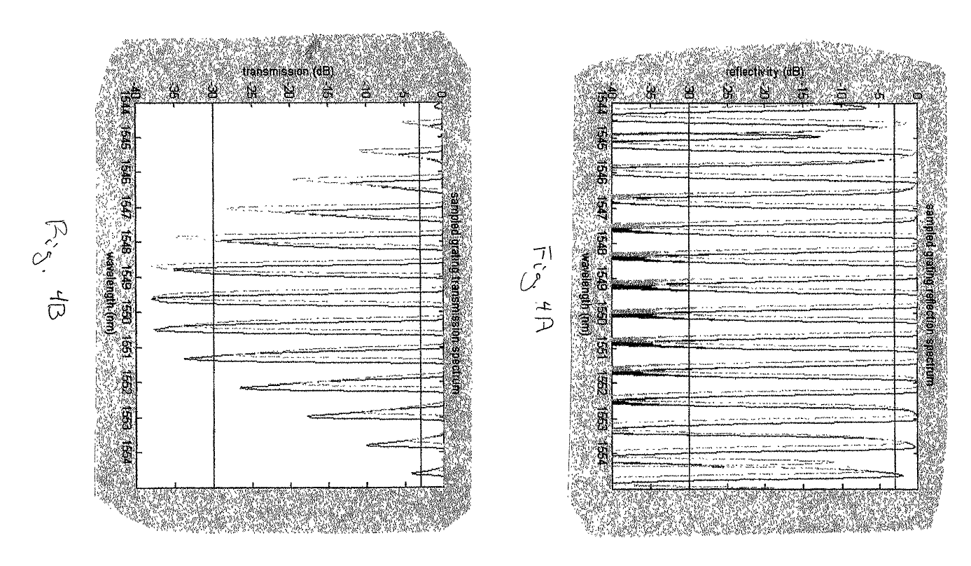

A nonlinearly chirped (i.e., a chirp in the grating period A) grating provides a straightforward solution to many of these applications, but requires lengthy gratings to obtain the useful bandwidth and requires very accurate control in the grating fabrication process, both of which are difficult to achieve. A linear chirp in the grating period, such as illustrated in FIG. 2, is easier to obtain. For many applications, sampled fiber gratings having a length as long as about 100 mm or longer with a small chirp rate, for example, in the order of about 0.1 nm/cm are acceptable. The chirp rate is the change in grating pitch or period Λ along the length of the fiber. FIG. 2 shows a linearly chirped, sampled grating in an optical fiber 21 which incorporates the chirp within each sampling segment 22 along the entire grating at a chirp rate of 0.1 nm/cm. The small chirp rate means very slight grating pitch difference for the adjacent grating field. To illustrate the chirp within each segment 22, the fiber 21 in FIG. 2 is illustrated against a plot of its segment periods, or pitch, Λ along the length of the fiber. Note that not only do the segment periods Λ increase along the length of the fiber 21, but the segment periods increase within each segment 22, as indicated by the small displacement on the Λ axis for each segment 22.

To fabricate the linearly chirped, sampled fiber gratings, phase mask technology has been used. The corresponding complex phase masks are fabricated with E-beam lithography technology and to ensure multiple channel operation, a precise, small chirp rate, i.e., a chirp rate typically ranging from about 0.01 nm/mm to about 0.05 nm/mm, is required. It is difficult, however, for standard E-beam lithography systems to write such small linear chirp (e.g., 0.1 nm/cm). A period difference between adjacent grating fields of the sub-0.01 nm order is currently unreachable for the E-beam writer. Thus, even linearly chirped, sampled long phase masks used to make chirped, sampled gratings are difficult and expensive to fabricate due to the critical precision requirements and time-consuming process required. The problem of inexpensively and reliably manufacturing chirp in sampled gratings remains.

On the other hand, the present invention is directed to step-chirped, sampled gratings. Instead of incorporating the chirp within each sampling segment along the entire grating, the chirp is introduced by varying the grating period Λ, or pitch, from one sampling segment to the next (or so) sampling segment while keeping the grating period within each sampling segment uniform. In accordance with one embodiment of the present invention, FIG. 3 depicts a linearly step-chirped, sampled grating in an optical fiber 23. Each sampling segment 24 has a uniform grating period within the sampling segment. The grating period varies from one sampling segment 24 to the next sampling segment 24 in a linear manner. As in the case of FIG. 2, the optical fiber 23 in FIG. 3 is illustrated against a plot of its segment periods Λ versus the length of the fiber. The segment periods Λ increase along the length of the fiber 23, but the segment periods remain the same in each segment. The encircling dotted line 31 indicates that a step in the chirp is one segment 24.

The use of the step-chirped, sampled grating relaxes the tight chirp requirement of the linearly chirped, sampled grating (FIG. 2) by a factor of 1/sr, where sr stands for the sampling ratio. For example, if the sr is about 10% (duty cycle d/S is 0.1), the improvement factor is 10. Furthermore, the error of the grating in each sampling segment 24 can only affect the grating within the sampling segment 24, not the chirp rate along the entire fiber 23.

While the step-chirped, sampled grating of the present invention may used in interleaver applications, application of such chirped gratings for WDM multichannel dispersion compensation where the channel bandwidth mainly depends upon grating chirp rate, grating length and duty cycle is more apparent. By carefully choosing these parameters, the step-chirped, sampled fiber Bragg grating may be used with an acceptable ripple in the group delay. For example, since for dispersion compensation applications, there is no cross-talk requirement (every channel is reflected) and bandwidth can be as large as the spacing between the channels. However, the reflectivity strength of every WDM channel should be identical as possible and this can be done with a small duty cycle.

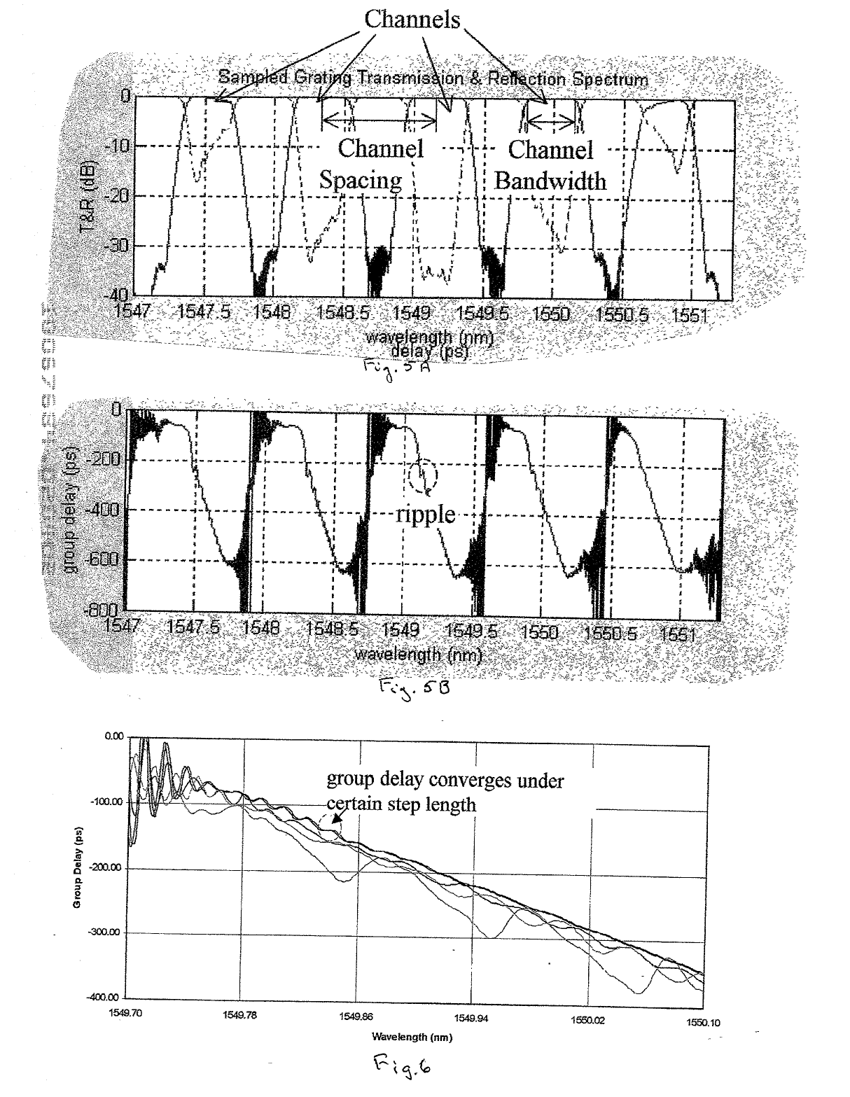

The effectiveness of the step-chirped, sampled grating can be seen by the graphs of FIGS. 4A and 4B. FIG. 4A is a plot of simulated results of reflectivity versus wavelength for a step-chirped, sampled fiber grating (dark line) and an equivalent continuously chirped, sampled fiber grating. Similarly, FIG. 4B is a plot of simulated results of transmission versus wavelength for the same two fiber gratings. By setting the step length of the step-chirped, sampled fiber grating properly, it is evident that the performance of the step-chirped, sampled grating matches that of the continuously chirped, sampled fiber grating.

FIGS. 5A and 5B show the simulated results of a step-chirped, sampled grating of FIG. 3. In FIG. 5A the transmission (dotted line) and the reflection (solid line) spectrum are shown for wavelengths about 1549 nm. FIG. 5B illustrates the group delay, which can be considered the amount of time a pulse requires to travel through the step-chirped, sampled grating, versus (the pulse's fundamental) wavelengths about 1549 nm.

In fact, the careful selection of parameters of a step-chirped, sampled grating allows for the chromatic dispersion compensation in WDM systems. Besides the grating period Λ, the plot of FIG. 3 shows these other parameters of the step-chirped, sampled fiber grating. L is the total length of the grating, S the sampling period; d the grating segment length; δ1 the length per step with uniform grating period; and ΔΛ the grating period increment per step. From these parameters are defined r, the chirp rate, which is equal to (Λ_{f}−Λᵢ)/L where Λᵢ is the grating period of the initial segment and Λ_{f} is the grating period of the last segment; and dc, the duty cycle, which is equal to d/S. In WDM systems channel spacing ΔCh can be 0.4 nm for 50 GHz spacing of channel signals; 0.8 nm for 100 GHz spacing and so on. Channel bandwidth may be smaller than channel spacing depending on the particular system requirements. In a step-chirped, sampled fiber grating:

Sampling period S=λ²/(2n*ΔCh)

where n is the index of refraction of the fiber core;

Channel bandwidth Bw=r*L*dc;

Group delay GD=2*n*L/c

where c is the speed of light in a vacuum.

Dispersion Dis=2*n/(r*dc*c)

These parameters characterize the attributes of optical signals traveling through the step-chirped, sampled fiber grating. An optical signal is a pulse in the time domain and a pulse in the frequency domain also. That is, the pulse is composed of many frequency components, as known from elementary Fourier analysis. If the group delay across the wavelength (inversely related to frequency) range of the pulse spectrum is constant, then every frequency component of the pulse travels at the same rate and the pulse shape is constant. If the group delay is different across the wavelength range of the pulse, then the pulse shape is affected. Chromatic dispersion compensation can occur if the group delay is smaller for the lower group speed components of the pulse traveling in an optical fiber (typically the longer wavelengths of the pulse spectrum) than the higher group speed components traveling in the optical fiber (typically the shorter wavelengths of the pulse spectrum). As might be expected, the group speed of the pulse spectrum varies gradually and smoothly over wavelength and therefore, the compensating group delay should likewise vary gradually and smoothly over wavelength. If there is a sudden jump in the group delay curve, i.e., a group delay ripple, then chromatic dispersion compensation is not good at that point and undesirable distortion in the pulse shape in time occurs.

Returning to the simulation results of the step-chirped, sampled fiber grating of the present invention, the group delay ripple is seen to be proportional to L², r and dc. GD ripple ∝1/step number∝r*dc*L². Approximately 3.02 steps/nm-cm is required to have a group delay ripple less than 10 ps under 20% apodization. For example, if the channel bandwidth Bw is 0.8 nm, the grating length L is 67 mm, the number of steps should be larger than 3.02*0.8*6.7≈16, which implies that length of each step should be less than approximately 67/16≈4.18 mm. Alternatively, the step length can be obtain by δ1=1/(3.02*r*L*dc). Note that apodization can improve the group delay ripple. With larger apodization length, less steps should be needed for fiber grating.

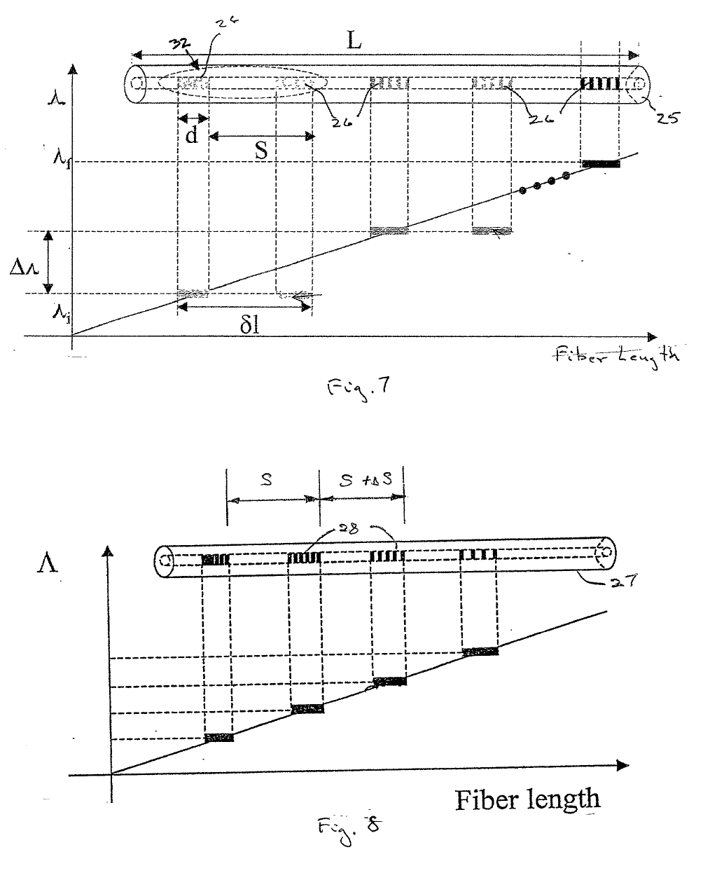

FIGS. 6 is a detailed plot of group delays versus wavelength for a step-chirped fiber Bragg grating with different step lengths. In this case, the grating length L is 67 mm, the chirp rate r is 0.4 nm/cm and the duty cycle dc is 30%. The plot illustrates that while the group delays for different step lengths are basically the same, the differences between the group delays, i.e., the group delay ripple, decreases with decreasing step length up to a certain amount and remains unchanged thereafter. That is, after a certain step length is reached, the group delay ripple is not further improved. This indicates an optimized, i.e., minimum, value of group delay ripple.

FIG. 7 illustrates another embodiment of the present invention. In this example, the same grating period Λ is used for two grating segments 26. Hence, as indicated by the dotted line 32, two grating segments form a chirp step. Note how δ1, the length per chirp step, is also changed from that of the fiber Bragg grating of FIG. 3. Of course, more than two grating segments may be used for a chirp step. Furthermore, in other embodiments of the present invention, a step-chirped, sampled grating may be interleaved with one or more step-chirped, sampled gratings. The chirp rates for these gratings may or may not be the same. If the chirp rates are the same, then grating periods should be different. Interleaving is useful where the index modulation amplitude of the fiber core is insufficient to support many reflection peaks with high reflectivity.

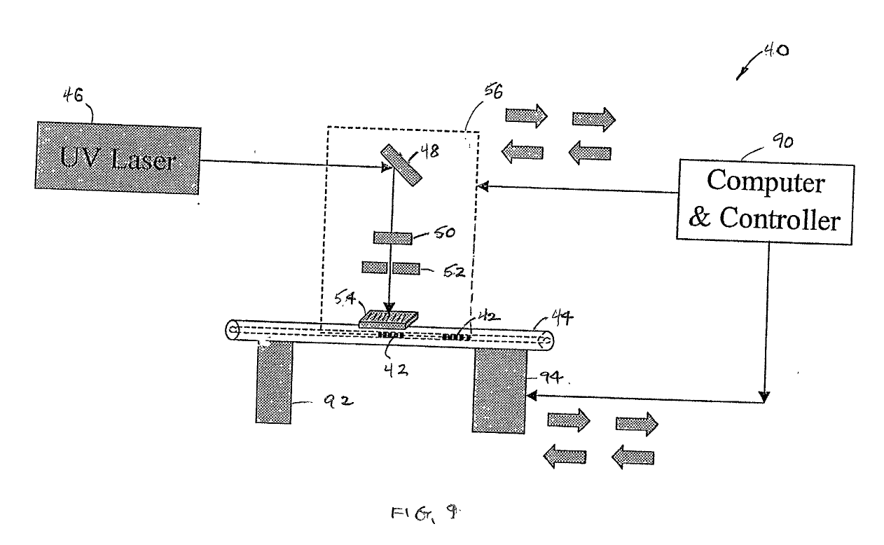

In addition to the chirp in the grating period, the grating can include a chirp in the sample function as well. In accordance with another embodiment of the present invention, FIG. 8 shows the step-chirped, sample grating in an optical fiber 25 which is similar to that of FIG. 3A but incorporates a chirped sample function. The sample period L_{S} between the sampling segments 26 is a function of the distance along the optical fiber. An initial sample period is S and the next period is S+ΔS. The ratio ΔS/S is the fractional change or chirp in the sample period S over the device length L. For example, the initial sample period is 1 mm and the sample chirp is 1.5%.

FIG. 9 illustrates an apparatus 40 for forming the step-chirped, sampled grating 42 on an optical fiber 44 according to another aspect of the present invention. A UV laser 46 produces UV light which is deflected by a deflection mirror 48 through a cylindrical lens 50, a beam shutter 52, and a phase mask 54, to the fiber 44. The deflection mirror 48, cylindrical lens 50, beam shutter 52, and phase mask 54 are included in a moving system 56 which is driven and controlled by a computer and controller 90 to move relative to the fiber 44. The fiber 44 is clamped in a fiber holder 92 at a slight distance from the phase mask 54 and within the coherent length of the UV laser beam. A translation stage 94 is connected to the fiber 44 for stretching the fiber 44.

To form the step-chirped, sampled grating 42, in one manufacturing method according to the present invention, a phase mask 54 of relatively short length with only a single uniform period, or pitch, is needed. The phase mask 54 is used to write the grating one sampling segment at a time as the moving system 46 transfers the UV light and phase mask 54 from one sampling location to the next along the fiber 44. The grating in every sampling segment is initially written with the same uniform grating period as defined by the uniform phase mask 54. The chirp in the grating periods among the sampling segments is introduced by permanently stretching the fiber 44 using the translation stage 94 under the precise control of the computer control system 90. Of course, other suitable ways of stretching the fiber 44 may be used instead. The sampled grating may be step-chirped by writing an initial sampling segment on the fiber 34, and then stretching the fiber 44 before writing each subsequent sampling segment. After writing all the sampling segments, the fiber 44 is returned to its original length by releasing the force applied to the fiber, so that subsequently written sampling segments after each stretch have increasingly smaller grating periods. The chirp in the grating periods may be linear (e.g., see FIG. 3) or nonlinear from one sampling segment to the next sampling segment. In addition, the moving system 56 can be controlled to form the grating that is sampled by a chirped sampling function or a uniform sampling function.

Alternatively, the phase mask 44 might have several mask segments of different periods for the chirp and the phase mask 54 sampled to induce the step-chirp in the fiber 44. The phase mask sampling can be performed by a sampling mask for the phase mask or moving the phase mask 44 with respect to the beam emanating from the lens 50. With these alternative manufacturing methods, the optical fiber 44 need not be stretched to obtain chirp.

The relatively long time in UV writing the gratings can be overcome by utilizing the computer and controller 90 for automated control. This process for forming a step-chirped, sampled grating eliminates the need to fabricate lengthy phase masks and avoids the difficulty of forming precise chirped gratings along the length of the fiber, thereby reducing manufacturing cost while achieving the desired performance. These step-chirped, sampled fiber Bragg gratings can be interleaved with others to obtain the advantages described above and incorporated into various fiberoptic devices, such as comb filters, interleavers, multiwavelength fiber lasers and chromatic dispersion compensators, to enhance the operation of WDM networks and the like.

Therefore, while the description above provides a full and complete disclosure of the preferred embodiments of the present invention, various modifications, alternate constructions, and equivalents will be obvious to those with skill in the art. Thus, the scope of the present invention is limited solely by the metes and bounds of the appended claims.

What is claimed is:

1. An optical waveguide grating device for coupling to a transmission optical fiber, said optical waveguide grating device comprising:
at least one sampled grating, said one sampled grating including a plurality of sampling segments having step-chirped grating periods monotonically increasing along a first direction of said optical waveguide grating device according to a chirp rate, each sampling segment having a uniform grating period within said sampling segment.

2. The optical waveguide grating device of claim 1 wherein said grating periods increase from one grating segment to the next grating segment in said first direction.

3. The optical waveguide grating device of claim 1 wherein said grating periods increase from a predetermined plurality of grating segments to the next predetermined plurality of grating segments in said first direction.

4. The optical waveguide grating device of claim 3 wherein said predetermined plurality of grating segments comprises two grating segments.

5. The optical waveguide grating device of claim 1 further comprising at least a second sampled grating interleaved with said at least one sampled grating, said second grating including a plurality of sampling segments having step-chirped grating periods monotonically increasing along said first direction of said optical waveguide grating device according to a second chirp rate, each sampling segment of said second grating having a uniform grating period within said sampling segment.

6. The optical waveguide grating device of claim 5 wherein said second chirp rate of said second sampled grating is the same as said chirp rate of said at least one sampled grating.

7. The optical waveguide grating device of claim 5 wherein said second chirp rate of said second sampled grating is different from said chirp rate of said at least one sampled grating.

8. The optical waveguide grating device of claim 1 wherein said step-chirped grating periods vary from one sampling segment to another sampling segment in a linear manner.

9. The optical waveguide grating device of claim 1 wherein said step-chirped grating periods vary from one sampling segment to another sampling segment in a nonlinear manner.

10. An optical waveguide grating device for coupling to a transmission optical fiber comprising:
an optical fiber; and
at least one sampled fiber Bragg grating in said optical fiber, said at least one fiber Bragg grating including a plurality of sampling segments which have step-chirped grating periods monotonically increasing along a first direction of said optical fiber according to a chirp rate, each sampling segment having a uniform grating period within said sampling segment.

11. The optical waveguide grating device of claim 10 wherein said grating periods increase from one grating segment to the next grating segment in said first direction.

12. The optical waveguide grating device of claim 10 wherein said grating periods increase from a predetermined plurality of grating segments to the next predetermined plurality of grating segments in said first direction.

13. The optical waveguide grating device of claim 12 wherein said predetermined plurality of grating segments comprises two grating segments.

14. The optical waveguide grating device of claim 10 further comprising at least a second sampled Bragg grating interleaved with said at least one sampled grating in said optical fiber, said second grating including a plurality of sampling segments having step-chirped grating periods monotonically increasing along said first direction of said optical fiber according to a second chirp rate, each sampling segment of said second grating having a uniform grating period within said sampling segment.

15. The optical waveguide grating device of claim 14 wherein said second chirp rate of said second sampled grating is the same as said chirp rate of said at least one sampled grating.

16. The optical waveguide grating device of claim 14 wherein said second chirp rate of said second sampled grating is different from said chirp rate of said at least one sampled grating.

17. The optical waveguide grating device of claim 10 wherein said step-chirped grating periods vary from one sampling segment to another sampling segment in a linear manner.

19. The optical waveguide grating device of claim 10 wherein said step-chirped grating periods vary from one sampling segment to another sampling segment in a nonlinear manner.

20. The optical waveguide grating device of claim 10 wherein said sampled fiber Bragg grating is chirped by writing a first sampling segment on the optical fiber and stretching said fiber before writing a second sampling segment so that said second sampling segment has a smaller grating period than said first sampling segment.

21. The optical waveguide grating device of claim 20 wherein said fiber Bragg grating of the sampling segments is formed using a single uniform phase mask prior to being chirped.

22. A method of forming an optical waveguide grating device, the method comprising:
forming a first sampled grating on an optical fiber, said first sample grating including a plurality of sampling segments with a uniform grating period; and
stretching said optical fiber between writing one sampling segment and writing another sampling segment to produce different grating periods of the sampling segments written before and after stretching the optical fiber.

23. The method of claim 22 wherein said first sample grating is formed under direct UV light exposure through a phase mask having a uniform pattern corresponding to said uniform grating period.

24. The method of claim 23 wherein a single uniform phase mask is used to form each of the plurality of sampling segments of the first sample grating.

25. The method of claim 22 wherein the optical fiber is stretched using a translation stage.

26. The method of claim 22 wherein the optical fiber is stretched a plurality of times between writing a plurality of the sampling segments to produce different grating periods in the sampling segments that are step-chirped, the grating period of each sampling segment being uniform.

27. The method of claim 26 wherein the step-chirped grating periods vary from one sampling segment to another sampling segment in a linear manner.

28. The method of claim 22 wherein said first sampled grating is formed and the optical fiber is stretched according to a chirped sampling function.

29. The method of claim 22 further comprising:
forming a second sampled grating on said optical fiber, said second sample grating including a plurality of sampling segments, said second sampled grating being interleaved with said first sampled grating.

30. The method of claim 29 wherein the sampling segments of said second sampled grating have grating periods that are step-chirped by stretching said optical fiber between writing one sampling segment and writing another sampling segment to produce different grating periods of the sampling segments written before and after stretching the optical fiber.

31. The method of claim 22 further comprising, after writing the sampling segments, returning the optical fiber to an unstretched length before the optical fiber is stretched.
